(19) United States
(12) Patent Application Publication
(10) Pub. No.: US 2024/0227049 A1
(43) Pub. Date: Jul. 11, 2024

(54) METHOD FOR MACHINING A TOOTH FLANK REGION OF A WORKPIECE TOOTH ARRANGEMENT, CHAMFERING TOOL, CONTROL PROGRAM HAVING CONTROL INSTRUCTIONS FOR CARRYING OUT THE METHOD, AND GEAR-CUTTING MACHINE

(71) Applicant: GLEASON-PFAUTER MASCHINENFABRIK GMBH, Ludwigsburg (DE)

(72) Inventor: Jürgen Kreschel, Hemmingen (DE)

(21) Appl. No.: 18/559,589

(22) PCT Filed: May 10, 2022
(86) PCT No.: PCT/EP2022/062597

§ 371 Date: Nov. 8, 2023

(30) Foreign Application Priority Data
May 25, 2021 (DE) 102021002704.3

(51) Int. Cl. B23F 1/02

(52) U.S. Cl. CPC B23F 1/02

(57) ABSTRACT

The invention relates to a method for machining a tooth edge, formed between a tooth flank and an end face of a workpiece tooth arrangement, by means of a tool tooth arrangement, in which method the tooth arrangements rotate about their respective tooth arrangement rotational axes in mutual rolling coupling. According to the invention, it is provided that the two tooth arrangement rotational axes be substantially parallel to each other and the machining be carried out over a plurality of workpiece rotations, wherein a first relative movement, parallel to the workpiece rotational axis, between the workpiece tooth arrangement and the tool tooth arrangement is carried out, and the position of the envelope of the tool tooth rolling positions is shifted relative to the engagement position of said envelope with the tooth flank of the workpiece tooth arrangement in the plane orthogonal to the workpiece rotational axis, transversely to the profile of the workpiece tooth arrangement, by means of a second relative movement, which is varied in particular according to the movement state of the first relative movement.

The invention relates to the field of supplementary tooth forming and specifically to a method for machining a tooth edge, formed between a tooth flank and an end face of a workpiece tooth arrangement, by means of a tool tooth arrangement, in which method the tooth arrangements rotate about their respective tooth arrangement rotational axes in rolling coupling.

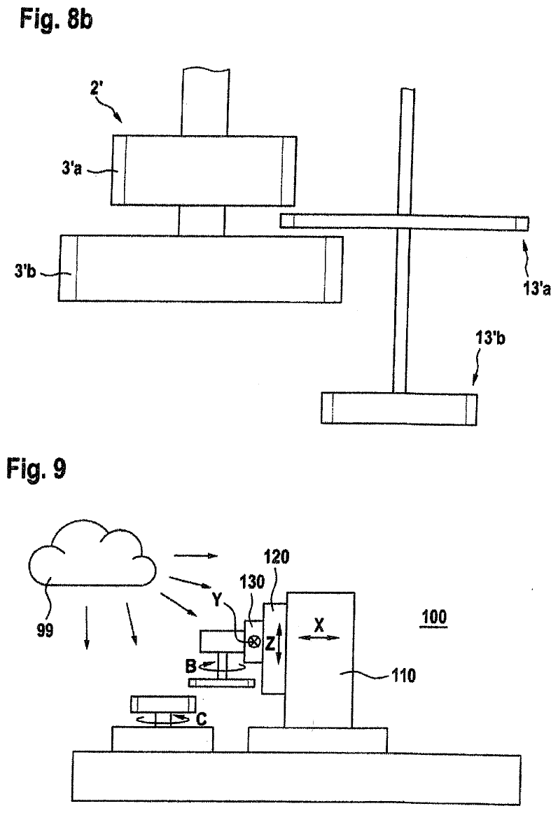

Methods for supplementary tooth forming are known; an overview can be found in Thomas Bausch, “Innovative Gear Manufacturing,” 3rd edition, on page 304. The starting point for supplementary tooth forming is the tooth arrangement after it has been produced, for example, by gear hobbing, gear shaping, or gear skiving. With such machining methods for producing tooth arrangements, so-called primary burrs initially appear along the end edge of the tooth arrangement, where the cutting edges of the machining tool emerge, as shown, e.g., in the literature reference Bausch in FIGS. 8.1-1, top center on page 304. These burrs are sharp-edged and firm and must be removed to avoid injuries and to improve the tooth arrangement geometry for the subsequent process. This is usually achieved using fixed deburring steels, entrained deburring discs or filing discs, and usually directly in connection with the production process of the tooth arrangement.

Such a mere removal of the primary burr, e.g., by turning or, as disclosed in DE 10 2014 018 328, by shearing it off with the rear side of a skiving wheel, often does not meet the requirements for the quality of the tooth edges. Therefore, a chamfer is usually formed on the tooth edges (end edges). In the literature reference Bausch, the end edge is denoted by B in FIG. 8.1-1 at the top left and shown in the figure at the top right with the chamfer produced thereon for a straight tooth arrangement. The invention relates to such methods in which the tooth edge, in the shape in which it was formed after the tooth arrangement was produced, is removed by material removal, and thus goes beyond the shearing off of primary burrs protruding from the tooth edge, which leaves the shape of the existing tooth edge as such unchanged.

A chamfering technique that has been widespread for a long time and is still used frequently is that of the so-called roller pressure deburring or roller deburring. In this case, the edges are plastically formed into the chamfer by pressing with roller deburring wheels. However, the material displacements that occur in the process lead to accumulations of material (secondary burrs) on the tooth flanks and on the end faces, which then in turn have to be removed using suitable measures. Such systems are described in EP 1 279 127 A1, for example.

While roller pressure deburring is a very simple method (usually, the gear-shaped tools do not even have to be rotationally driven; instead, they can be held freely with contact pressure against the workpiece tooth arrangement to be chamfered and then run in rolling coupling with the driven workpiece), the secondary burrs thus created are a disadvantage of this method. While the secondary burrs on the end faces can still be sheared off again comparatively easily, for example, using a deburring steel, the secondary burrs produced in particular on the tooth flanks are a problem for any hard-fine machining that may still be carried out after the workpieces have been hardened. If these flank-side secondary burrs are to be removed prior to said hardening, a further machining pass on the machine producing the tooth arrangement with the deepest infeed is possible, or the use of special tools, as described, for example, in DE 10 2009 018 405 A1.

WO 2009/017248 proposes shifting the weight of secondary burr generation away from the tooth flank towards the end face. However, further approaches in technology go in the direction of bringing about the material removal/the formation of the chamfer in a cutting instead of a pressing manner by removal with a geometrically defined or geometrically undefined cutting edge (DE 10 2016 004 112 A1).

For cutting chamfering with a geometrically defined cutting edge, variants have become known (EP 1 495 824 A2) in which a machining tool used to chamfer the tooth edges is arranged on the same shaft as a hob used to produce the workpiece tooth arrangement, but separate arrangements are also possible (DE 10 2009 019 433 A1) which allow the cut to be made from the inside to the outside by pivoting the chamfering tool when machining the front ends on one end face and also on the other end face.

DE 10 2013 015 240 A1 discloses the so-called “chamfer cut units” which look similar to a hob, but in which the cutting circles of the same profile regions overlap, wherein the profiles are designed such that, when a chamfering cutter tooth passes through a tooth gap of the workpiece tooth arrangement, the latter is completely chamfered on both flanks of the tooth gap. A further cutting chamfering more closely oriented to gear hobbing is described in DE 10 2018 001 477 A1. In this case, the chamfering is carried out using the single-flank method in several cuts as a plurality of tool teeth passes through the workpiece tooth gap. For example, for the machining of a flank, the pivot angle that pivots the tool rotational axis in relation to the horizontal, for example, at a vertical workpiece axis, can even be set to zero.

According to a principle similar to the “chamfer cut unit” disclosed in DE 10 2013 015 240 A1, there is also a fly cutter-like removal on the tooth edge, used to create a bevel, e.g., for gear teeth arrangements, in which rotating fly cutters, realized, for example, in the form of an end mill, are lined up with their tool rotational axis in such a skewed manner to the axis of the workpiece tooth arrangement that a tooth flank of the workpiece tooth arrangement is machined in a single pass through the machining zone by a cutting process parallel to the final geometry to be produced. A second fly cutter tool can be used for the other workpiece tooth flank. This is described, for example, in the literature reference Bausch on page 323.

A still further method for cutting chamfering is disclosed in WO 2015/014448. In this case, the starting point is the gear skiving tooth arrangement engagement with an axis intersection angle and, compared to the normal position in the gear skiving method, the tool axis is additionally tilted to change the cutting movement, which is then used to create the chamfer. The method disclosed in DE 10 2014 218 082 A1, in which a skewed axis configuration is already structurally integrated into the gear-cutting machine, is based upon the same principle. With these two chamfering processes, which work according to the principle of gear skiving, the cutting mechanism takes place via the axis intersection angle, and thus similarly to gear skiving.

Yet another chamfering technique has become known from DE 10 2018 108 632, in which an end milling cutter is moved along the tooth edge by machine axis movement. This chamfering technique is particularly well-suited for end edges that cannot be easily reached using “chamfer cut units” or gear hobbing-type tools due to interfering contours on the workpiece.

The object addressed by the invention is that of developing a method of the initially mentioned type aiming at a good combination of comparative simplicity and satisfactory flexibility of the tooth edge machining.

This object is achieved from a technical point of view by a technical development, which is substantially characterized in that the two tooth arrangement rotational axes are substantially parallel to each other, and the machining is carried out over a plurality of workpiece rotations, wherein a first relative movement, parallel to the workpiece rotational axis, between the workpiece tooth arrangement and the tool tooth arrangement is carried out, and the position of the envelope of the tool tooth rolling positions is shifted relative to the engagement position of said envelope with the tooth flank of the workpiece tooth arrangement in the plane orthogonal to the workpiece rotational axis, transversely to the profile of the workpiece tooth arrangement, by means of a second relative movement, which in particular is varied according to the movement state of the first relative movement.

In the method according to the invention, cutting is not carried out along or parallel to the surface of the new surface shape to be formed—in particular, a chamfer—but, due to the tooth arrangement rotational axes that are substantially parallel to each other and due to the shifting of the envelope, in slices in planes that are substantially orthogonal to the workpiece rotational axis. The surface formed in place of the original tooth edge, e.g., a chamfer, is composed of the end regions of the slice-like material removal achieved via the envelope which is varied according to the movement state of the first relative movement. Depending upon the desired lesser roughness of the chamfer surface, for example, the number of machining processes or workpiece rotations performed during the axial first relative movement can be selected to be correspondingly higher, and thus the number of “slices” can be selected to be higher. Material is thus removed from the material on the workpiece tooth flanks. The tooth flanks of the tool tooth arrangement act as machining surfaces of the machining.

In this way, the first relative movement can be carried out in a simple design as an axial feed movement with a correspondingly large number of feed steps. In this case, the second relative movement could run in an oscillating manner in that it is reset to the engagement position (zero position) before each next feed step. With a view to faster machining times, however, it is preferred that the first relative movement be carried out as a continuous feed movement, for example, with a linear progression over time, e.g., via a machine axis Z parallel to the workpiece rotational axis C. With increasing feed rate Z(t), the tool tooth arrangement, as seen relative of the workpiece rotational axis, increasingly overlaps the tooth gap in the region of the machined end face of the workpiece tooth arrangement. For example, in the course of machining, the tool tooth arrangement immerses as far into the workpiece tooth arrangement as is desired for the machining of the tooth edge when creating a chamfer up to the chamfer depth. Without the additionally executed shifting of the envelope relative to the engagement position of the envelope with the workpiece tooth arrangement in rolling coupling, the workpiece tooth arrangement and the tool tooth arrangement could, for example, roll off each other like gear and mating gear, at least in some regions or also completely along at least one tooth flank if, according to a preferred embodiment, the profile of the tool tooth arrangement is designed as a mating profile to the tooth profile of the workpiece tooth arrangement. However, due to the shifting of the envelope into the material of the workpiece teeth, the above-mentioned material removal “in slices” occurs, which starts at the end face and extends to the desired extension of the machined region—for example, the chamfer width. The desired chamfer surface can then be produced by reducing the shift with increasing feed rate. If the shifting movement is also executed as a linear shifting over time, substantially planar surface regions can be formed in the example of the generated chamfer surface (or substantially straight profiles as seen in the section on the pitch circle); by deviation or non-linearly selected V(Z), whereby V stands for the second relative movement and Z for the first relative movement, it is also possible to generate almost any desired profile of the machining region and thus, for example, also curved chamfers.

In a particularly preferred embodiment, a transverse movement of the workpiece and/or the tool tooth arrangement running transversely to the center distance axis of the rotational axes contributes to the second relative movement. In principle, a shifting in the direction of the center distance axis (radial) is also conceivable, but, precisely with the typical engagement angles of a large number of workpiece tooth arrangements, the transverse movements mentioned are more suitable, wherein the radial movement can be included—in particular if (as will be explained later) machining in the base region is also desired.

In an embodiment that is again preferred in this context, the transverse movement comprises an additional rotation ΔC of the workpiece tooth arrangement. This is easy to implement in terms of control and makes it possible to realize simple processing machines, for example, without a tangential machine axis. This additional rotation is to be understood as an additional rotation that goes beyond any additional rotation possibly occurring with helical tooth arrangements to maintain the rolling coupling.

In an alternative or additional variant, the transverse movement can comprise a movement of a linear machine axis whose directional component orthogonal to the workpiece rotational axis and orthogonal to the center distance axis predominates over the respective directional component along these axes. In a simply designed machine axis configuration, this linear axis could be a tangential axis Y which extends transversely, and in particular orthogonally, to the radial axis (X) and an axial (parallel to the workpiece axis) axis Z. Since the effect of the additional rotation ΔC, depending upon the tool, also includes a radial component when compared to such a Y component, for example, a combination of these two transverse movement components of additional rotation ΔC and linear movement ΔY allows for a variation of the machining to be set via the tooth height of the workpiece tooth arrangement. Instead of or together with an additional rotation of the workpiece tooth arrangement, an additional rotation ΔB of the tool tooth arrangement could also be used.

The method also provides for the possibility of machining the tooth edge in the tooth base of the workpiece tooth arrangement. For this purpose in particular, it is preferably provided that a radial movement of the workpiece and/or the tool tooth arrangement running in the direction of the center distance axis of the rotational axes contribute to the second relative movement. In a particularly simple design, it would be possible to also work only with the radial movement as the second relative movement, but this would couple the chamfer in the base region with the chamfer shape in the flank region if a chamfer were produced. It is therefore particularly preferably provided that, in addition to the radial movement, a transverse movement also be carried out according to one of the mechanisms described above. The second relative movement is then guided in a form having tangential and radial components.

In this connection, it can also be provided that the shape of the chamfer in the tooth base be effected by adjusting the radial movement according to the movement state of the first relative movement, and the shape of the material removal at the tooth edge in the tooth flank region be determined by adjusting the transverse movement according to the movement state of the first relative movement and the movement state of the radial movement. This allows the design of the reworked tooth edge in the flank region to be decoupled from that in the base region. As usual, a chamfer width for the tangential direction Y can be calculated from information about the engagement angle related to the flank normal directions.

In a further preferred embodiment, the profile of the material removal profile in the tooth height direction is determined by superimposing the transverse movement contributions from the additional rotation and the linear machine axis movement. As already indicated above, greater variability in the design, for example, of a reworked tooth edge, such as a chamfer, is thus achieved.

A further expedient embodiment could be carried out with a further machining pass—in particular with otherwise identical or preferably phase-shifted (e.g., by 180°) coupling of the movements, and preferably with movement control carried out with the reverse movement direction of the first relative movement. With such a further machining pass, any chips that have not been completely detached from the material of the remaining workpiece tooth can be sheared off. The emerging or retreating movement is thus preferably used to smooth the surface formed during immersion. For example, with the same return stroke as feed rate per workpiece revolution, the height of the steps (see below in FIG. 2) on the chamfer surface is halved by, e.g., a phase shift of 180°. Insofar as an alternative or additional chip separation is required, brushes, for example, could also be used.

In a particularly preferred embodiment, the rotational speed at the tooth tip of the workpiece is at least 10 m/min, more preferably at least 20 m/min, and in particular at least 40 m/min. More preferably, these rotational speeds are even higher than 60 m/min, more preferably than 120 m/min, and in particular than 180 m/min. The machining can accordingly take place approximately at orders of magnitude of rotational speeds that also occur, for example, during gear skiving of typical tooth arrangements. In this way, with reasonable cutting conditions, the total machining time is kept within reasonable limits even if a large number of workpiece rotations are carried out—for example, 3 or more, but also 6 or more, and even 10 or more.

In a preferred embodiment, the feed rate per workpiece revolution for the first relative movement is at least 2 μm, preferably at least 4 μm, even more preferably at least 10 μm, and in particular at least 20 μm, and/or no more than 0.6 mm, preferably no more than 0.4 mm, and in particular no more than 0.2 mm.

With the method, not only chamfers, but also, for example, bevel-like structures can be produced on tooth arrangements—for example, for shifting-gear tooth arrangements. In a particularly preferred embodiment of the method, the machining produces a chamfer on the tooth edge, the chamfer width of which is preferably less than 30%, and in particular less than 20%, of the tooth thickness on the pitch circle.

Variants are conceivable in which the tool tooth arrangement has differently designed regions and is designed in particular as a tooth arrangement formed over a certain region of profiles, and, if necessary, the machining is designed as several machining passes in which different tooth arrangement regions carry out the machining of different regions in the tooth height direction of the workpiece tooth arrangement. However, in a particularly preferred embodiment, the profile of the tool tooth arrangement is substantially that of the counter-tooth arrangement of the workpiece tooth arrangement with respect to rolling coupling. In this case, the tool tooth arrangement is a workpiece-specific tooth arrangement when compared to universal tools. However, this does not mean that the two-flank method must be used. Instead, it is preferred that the machining be carried out using the single-flank method, wherein the other tooth flank(s) then is/are machined, e.g., following the machining of one tooth flank on one of the respective tooth gap(s) of the workpiece.

In such a single-flank method, too, it is preferred that the other tooth flank(s) be machined with the same tool and/or the same clamping process as the one tooth flank. This simplifies the method sequence and reduces the number of tools to be used.

In a further expedient embodiment, the tooth thickness of the tool tooth arrangement is reduced when compared to the tooth thickness required for the rolling coupling for two-flank machining. This reduces the risk of collision on the opposite flank.

In the sense of a full tooth arrangement, the tool tooth arrangement can also have a suitable tool tooth for each tooth gap of the workpiece (pitch without skip factor). However, the method can also be carried out with fewer teeth than the full tooth arrangement, e.g., with a skip factor of 2 or 3, but preferably still with at least a number of teeth that ensures that, on average, a skip factor of 4 is not exceeded, and in particular a skip factor of 3 is not exceeded.

In a preferred embodiment, the tool tooth arrangement can be designed to be thin with respect to the dimensions in the direction of the tool rotational axis—for example, with a dimension in this regard of no greater than 1.5 cm. Since the work output of the tool tooth arrangement is lower when compared to the work output of tools producing tooth arrangements, even significantly thinner tooth arrangements can be used, even those with a dimension of less than 1 cm, and further preferably of less than 0.7 cm, but variants with smaller disk thicknesses of the tool tooth arrangement of 0.4 cm or less down to disk thicknesses no greater than 3 mm, and even 2 mm are also conceivable. If work is to be carried out in the miniature range, disk thicknesses of no more than 1 mm, even no more than 0.5 mm, in particular no more than 0.3 mm, produced, for example, by wire EDM, are also taken into consideration. With such tools, tooth edge machining can also be carried out when there is only little (axial) machining space available due to shoulders or other interfering contours, for example, of workpieces with several tooth arrangements.

The tool can be made of solid material, and also be sintered, and in particular designed as a disposable tool. A main body could also be fitted with cutting teeth or groups of cutting teeth, for example, in the form of cutting inserts, and in particular reversible cutting inserts. Constructive clearance angles can be formed by indentations in the tooth end faces. Alternatively or additionally, wedge angles of less than 90° can be achieved by using tool tooth flanks designed to be conical.

For a superimposition of contributions of different machine axes for realizing the shifting movement of the envelope, it is favorable to start with the idea of a discrete feed in the axial direction and to look at the (desired) shift to be achieved for a given axial penetration depth. For example, it would be possible to first determine the radial movement X(Z) via the desired radial penetration depth at the tooth base, at which neither tangential nor additional rotations make a noticeable contribution to shape modification. Determining, e.g., Y(Z) is then carried out by taking into account that, according to the engagement angle, the radial shift X(Z) also causes an additional contribution in the Y direction. If the workpiece rotational axis is included, depending upon the precision requirements, it can be taken into account that the shift via ΔC also has a component in the radial direction that must be included, which varies slightly via the tooth height of the workpiece tooth arrangement. Using both ΔC and ΔY results in an additional degree of freedom with which the design of the chamfer can also be varied via the tooth height—for example, to create comma-shaped chamfers. The radial axis X is also available as a further degree of freedom for machining of the latter, which in any case leaves out the tooth base.

As already explained above, a surface formed using the method can be composed of the end regions of the material removals achieved via the envelope, which varies according to the movement state of the first relative movement. This type of producing new tooth arrangement surfaces (regions) is disclosed by the invention as independently worthy of protection, regardless of the precise function of the new tooth arrangement surface and the specific orientation of the tooth arrangement rotational axes relative to each other. For this purpose, the invention provides as a further aspect a

Method for machining a tooth flank region of a workpiece tooth arrangement—in particular, a tooth edge, formed between a tooth flank and an end face of a workpiece tooth arrangement—by means of a tool tooth arrangement, in which method the tooth arrangements rotate in rolling coupling about their respective tooth arrangement axes, and in which the machining on the tooth flank region creates a new tooth arrangement surface, which is substantially characterized in that the machining is carried out over a plurality of workpiece rotations, wherein a first relative movement with a directional component parallel to the workpiece rotational axis is carried out between the workpiece tooth arrangement and the tool tooth arrangement, and, by means of a second relative movement which is varied in particular according to the movement state of the first relative movement, the position of the envelope curve of the tool tooth arrangement relative to its engagement position with the tooth flank of the workpiece tooth arrangement is shifted transversely to the profile of the workpiece tooth arrangement and in particular orthogonally to the tool rotation axis, as seen in projection on the plane orthogonal to the workpiece rotational axis C, and as a result, material is removed along a cutting surface during one pass of a respective workpiece rotation, wherein the shape of the new tooth arrangement surface is composed of the end regions of the cutting surfaces of the plurality of workpiece rotations. Therefore, cutting preferably takes place in a plane which lies substantially orthogonal to the tool rotational axis.

It goes without saying that the aspects described above for preferred embodiments, and in particular for the formation of a phase as a new tooth arrangement surface, can also be used for the method just defined.

In a preferred design, the tooth arrangement axes of the tool and the workpiece could both lie in the same plane, but one could be inclined at an angle relative to the other. This axis position can be particularly suitable for cases in which a region close to the end edge is being machined, and the relevant end plane of the tooth arrangement does not run orthogonally to the workpiece axis, but is also inclined with respect to said region. The inclination of the relative axes could then be adjusted to this inclination value of the end face with respect to the orthogonal plane to the workpiece rotational axis.

In addition to the creation of phases as new tooth arrangement surface regions, the creation of bevels has already been addressed. In this context, a lead-in surface of a starter pinion could also be created.

With regard to the above-mentioned inclination angle, it could also be provided that new tooth arrangement surfaces on bevel or beveloid tooth arrangements be created, wherein the tool is applied at such an angle that the cutting profile of the tool is arranged parallel to the profile of the phase on a conical outer side of the bevel tooth arrangement by way of orienting the axes of tool and bevel gear.

In this connection, it is also provided that, for creating the new tooth arrangement surface, and in particular a phase, not only cylindrically-toothed workpieces be used, but also convex tooth arrangements or, in particular, said bevel gear tooth arrangements. In this connection, it is preferred to work with bevel gear tooth arrangements (beveloids and hypoids) that are designed for axis angles of less than 60°, further preferably of less than 40°, and in particular of less than 30° (correspondingly with a conicity for the individual workpiece of about half of these values). Accordingly, the inclination angle of the tool could then be adjusted to the rolling cone angle of the bevel gear.

In a further preferred embodiment, the tooth arrangement tool could already be integrated into a tool arrangement having a main tool or in the main tool which is integrated into the workpiece tooth arrangement on which a new tooth arrangement surface—in particular, a chamfer—is produced using the method. In particular, the tooth arrangement could be produced with the rear side of a shaping wheel (for gear shaping) or a skiving wheel (for gear skiving). In particular for main machining that produces by gear skiving, it could be taken into consideration to design the tool as a combination tool with the chamfering tool, and in particular in the form of two disk-like tools that are arranged in particular directly one above the other in the axial direction, so that their rotational axes coincide. Such a tooth arrangement tool could also be formed on a first end face with the cutting edges for gear skiving with a profile designed for gear skiving, and on the rear side, it could be formed with a profile designed for gear shaping of the identical tooth arrangement, which profile would then be designed with parallel axes (as with gear shaping) or possibly with axes preferably lying in one plane but at an inclination angle to each other, while an axis intersection angle is set for the skiving process that produces the tooth arrangement, for which the skiving process is designed.

According to a further aspect, the new tooth arrangement surface would not necessarily have to adjoin an end face of the machined tooth arrangement. For example, producing pockets with rotational axes that are in particular inclined to each other or in particular parallel are also considered. For this purpose, the tooth arrangement tool could also be manufactured as a very thin disc and initially, in a first step, a correspondingly thin incision not yet made over the full pocket width be used, possibly with an oscillating second relative movement up to the desired pocket depth, but still at the same height in the workpiece axis direction, and subsequently the method steps be used as in the production of a phase according to the above description, but with the same extension of the transverse movement for the formation of uniformly deep incisions until the full axial pocket width is reached.

In this respect, it can be seen and is disclosed that the method can definitely and preferably be carried out with tooth arrangement rotational axes that are parallel to each other in order to machine a tooth edge by machining with the first and second relative movement—in particular, to produce a chamfer—but the method with the composition of the new tooth arrangement surface from the end regions of the cutting surfaces from the plurality of workpiece rotations can also be used for new tooth arrangement surfaces in which work is carried out with non-parallel tooth arrangement rotational axes or in which no machining of the tooth edge, and in particular no formation of a chamfer surface as a new tooth arrangement surface, takes place.

In a further possible embodiment, a modification function is provided in which modified machine axle controls are associated with a virtual geometry for the new tooth arrangement surface, and the virtual geometry in a first transition region from a central region to the end face and/or in a second transition region from the central region to the tooth flank deviates from a target geometry on the workpiece (for example, defined via the (typical) combination of the chamfer width and chamfer angle parameters) in a manner that removes more material, wherein the processing is based upon the modified machine axis controls—in particular, after selection of the modification function or automatically. In this way, any formation of material warps on the machined tooth flank region caused by compressive forces between the machining tool and the workpiece tooth arrangement can be counteracted.

The provision of such a modification function can also be advantageous independently of specific machining kinematics and/or shape of machining tools—in particular, in methods in which such compressive forces can occur and/or the material of the workpiece tooth arrangement cannot offer a sufficient flow resistance to counteract any occurring compressive forces. In this respect, the invention also discloses, independently and patentable on its own, a method for machining a tooth flank region of a workpiece tooth arrangement—in particular, a tooth edge, formed between a tooth flank and an end face of a workpiece tooth arrangement—using a machining tool, in which a new tooth arrangement surface—in particular, in the form of a chamfer—is formed by the machining at the tooth flank region, with a modification function in which modified machine axis controls are associated with a virtual geometry for the new tooth arrangement surface, and the virtual geometry in a first transition region from a central region to the end face and/or in a second transition region from the central region to the tooth flank deviates from a target geometry on the workpiece in a manner that removes more material, wherein the processing is based upon the modified machine axis controls—in particular, after selection of the modification function or automatically—in order to counteract any formation of material warps on the processed tooth flank region caused by compressive forces between the machining tool and the workpiece tooth arrangement.

The modification function could be implemented in the form of a manner automatically executed by the control and possibly take place in the background in a way that is not detectable for an operator of the machine. However, it is also provided that the modification function be an option selectable when operating the machine executing the method. For example, after noticing a deviation of the new tooth arrangement surface generated without a modification function, the operator could activate the modification function.

In a further preferred embodiment, parameters of the modification function can be variable and can be determined in particular by operator inputs. In this connection, for example, a shape and/or size of the deviation can be input and/or can be selected (from pre-selected options).

For example, the shape of the deviation could be implemented in a rounding or a bevel. If, for example, a (e.g., 45°) chamfer is desired on a straight tooth arrangement and corresponds to a desired target geometry on the workpiece, the virtual chamfer geometry, for example, can transition into a bevel with a higher angle before reaching the end face, and/or into a bevel with a smaller angle (in relation to the tooth flank in each case) before reaching the tooth flank.

If, for instance, 5 denotes the chamfer angle (of the central region) of the chamfer, this lower angle (ε) should preferably be at least 15° lower than δ and/or be not more than 30°, and preferably not more than 20°. The same applies to the higher angle (η), which then preferably is not less than 15° greater than δ and/or is greater than 60°—in particular, than 70°.

Furthermore, it is preferred that the chamfer width (bs) of the virtual geometry with a predetermined chamfer angle δ (in the central region) and is at least 2%, preferably at least 5%, and in particular at least 10%, greater than the chamfer width resulting from the chamfer being continued at the same angle α. The same preferably also applies to the chamfer extension (bf) in the flank direction.

In a further preferred embodiment, it is provided that, alternatively or in addition to the implementation of such a modification function, an input option be provided for an (extended) chamfer target geometry, which, in the context of the above explanations, provides the extended input options corresponding to the definition of the virtual geometry—in particular, also in the form of design offers deviating from the target geometry on the workpiece after input of basic chamfer data such as chamfer width and chamfer angle. Accordingly, if an input of chamfer geometry data deviating from the target geometry on the workpiece already takes place in a manner defining the first or second transition region as explained above, these (expanded) chamfer data can be used as a basis for the machine axle control, corresponding to the use of the virtual geometry of the modification function as a basis.

The expanded chamfer data thereby preferably define transition regions at least on the end face and/or on the flank side to the central region of the chamfer, the shaping of which deviates from that of the central region—in particular, in the form of a rounding or bevel. In the case of a rounding, the above angle values preferably likewise apply, in the form of the tangent slope averaged over the rounding.

It is understood that the described modification function and/or the input option with extended chamfer data is preferably used for machining methods according to one or more aspects of the machining method explained at the outset.

In terms of device technology, a chamfering tool is provided for machining a tooth edge formed between a tooth flank and the end face of a workpiece tooth arrangement, with machining carried out substantially with tooth arrangement rotational axes parallel to each other in mutual rolling coupling in the form of a tool tooth arrangement with machining surfaces formed by the tooth flanks of the tool tooth arrangement—in particular, designed for machining according to a method according to one of the aspects described above and/or having the design characteristics set forth above.

The invention is also protected by a control program containing control instructions that control the machine for carrying out a method according to one of the aforementioned method aspects when executed on a control device of the gear-cutting machine.

Furthermore, the invention provides a gear-cutting machine having at least one workpiece spindle for rotatingly driving a workpiece tooth arrangement about its workpiece rotational axis, and at least one tool spindle for rotatingly driving a tool tooth arrangement about its rotational axis, at least one first machine axis which allows for a first relative movement, parallel to the workpiece rotational axis, between the workpiece tooth arrangement and tool tooth arrangement, characterized by a control device having control instructions for carrying out a method according to one of the aforementioned method aspects.

The gear-cutting machine can be a larger machine complex that also includes a main tool spindle for producing the tooth arrangement. However, the gear-cutting machine can also be designed as an independent chamfering station. In a simple design, a machine axis is provided with the main component in the direction of the workpiece rotational axis, for the first movement preferably in the direction of the workpiece rotational axis. For vertical machines, this would be the vertical axis.

A radial axis is preferably also provided in order to keep the station usable for workpieces and tools of different diameters, and optionally as an additional feed axis. In a further embodiment, a tangential axis can also be realized as a linear machine axis, preferably orthogonal to the radial axis and orthogonal to the workpiece rotational axis. In a particularly preferred embodiment, the chamfering station does not have a pivot axis or tilt axis that could change the parallel arrangement of the tool rotational axis and the workpiece rotational axis. The linear tangential axis can preferably also be omitted in order to design the station in a simple manner.

The tool rotational axis is preferably an axis driven via a direct drive or also via an indirect drive. It goes without saying that there is a controller for the machine axes designed as NC axes, which is able to maintain a synchronous rolling coupling and bring it out of phase in a targeted and controlled manner by means of additional rotations. In this context, a centering device is preferably provided, which, for example, has a non-contact centering sensor.

The chamfering wheels, which are also very thin according to the invention, also allow tooth edge machining under unfavorable space conditions, such as those caused by interfering contours, and can also be designed as a tandem tool, for example. A non-rotatably connected combination of a skiving wheel for producing the workpiece tooth arrangement and the chamfering wheel according to the invention is also conceivable. The machine axes of the main machining unit are then available for chamfering, but at the cost of longer non-productive times. It is also possible to couple two chamfering wheels according to the invention designed for different workpiece tooth arrangements in a non-rotatable manner to form a tandem tool, for example, for chamfering different workpiece batches without changing tools or machining workpieces with two or more different tooth arrangements.

Further features, details and advantages of the invention will be apparent from the following description with reference to the accompanying figures, wherein:

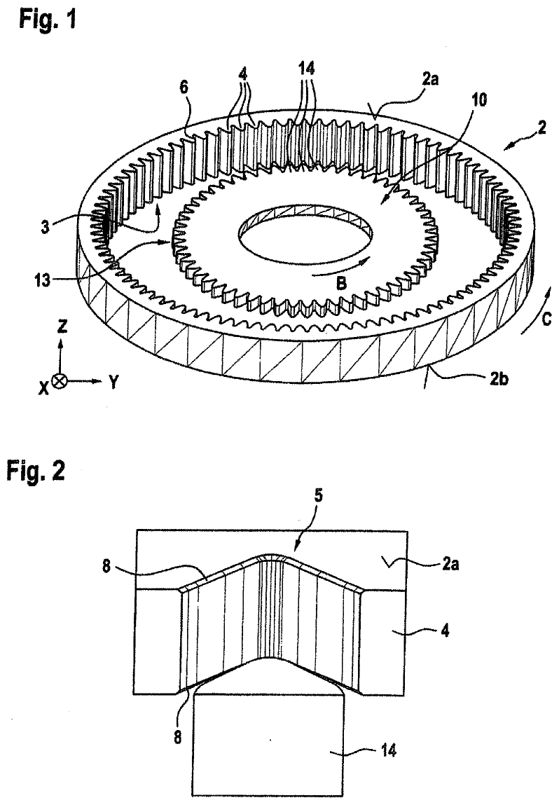

FIG. 1 shows a gear-shaped tool and a tooth arrangement machined by the tool,

FIG. 2 shows a section of the workpiece with a produced chamfer,

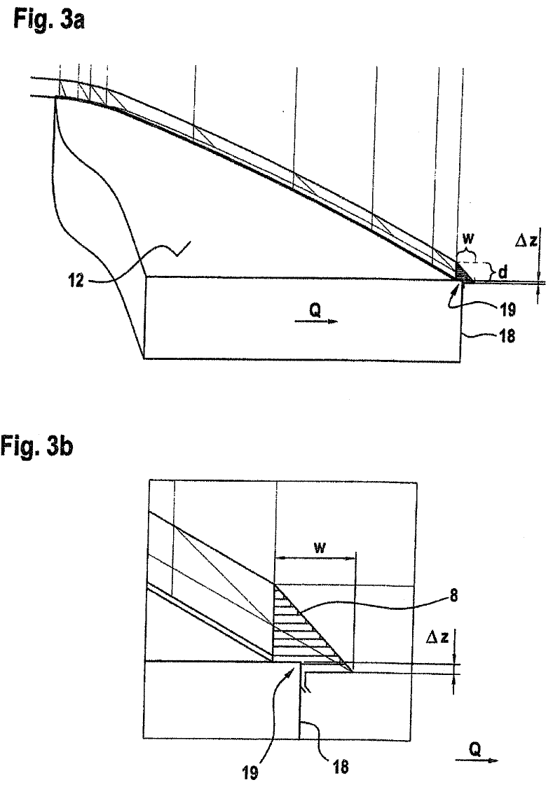

FIG. 3a shows an explanatory view for producing the chamfer,

FIG. 3b shows an enlarged section from FIG. 3a,

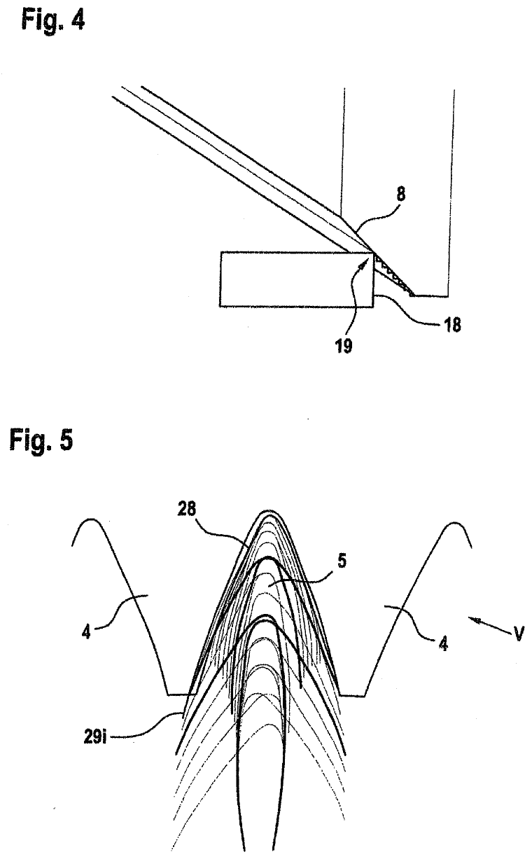

FIG. 4 shows a momentary position during a retreating movement,

FIG. 5 shows an envelope shifted with respect to a workpiece tooth profile,

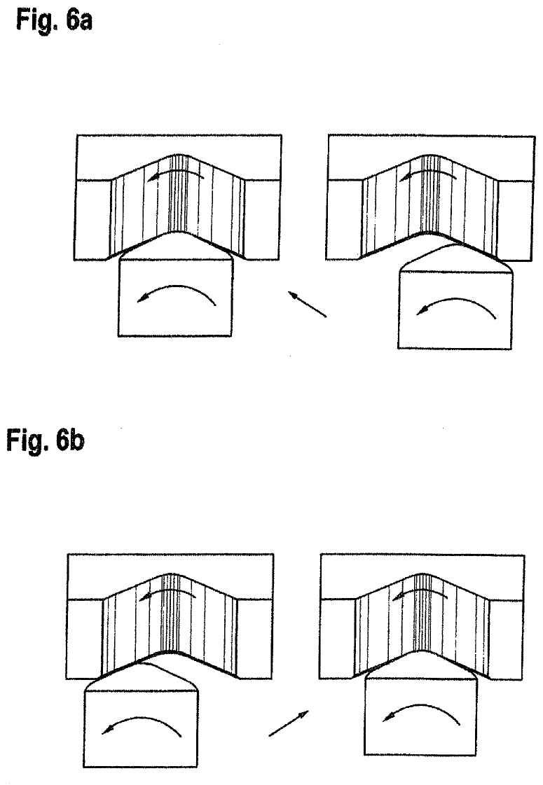

FIGS. 6a, 6b show explanatory views of single-flank machining,

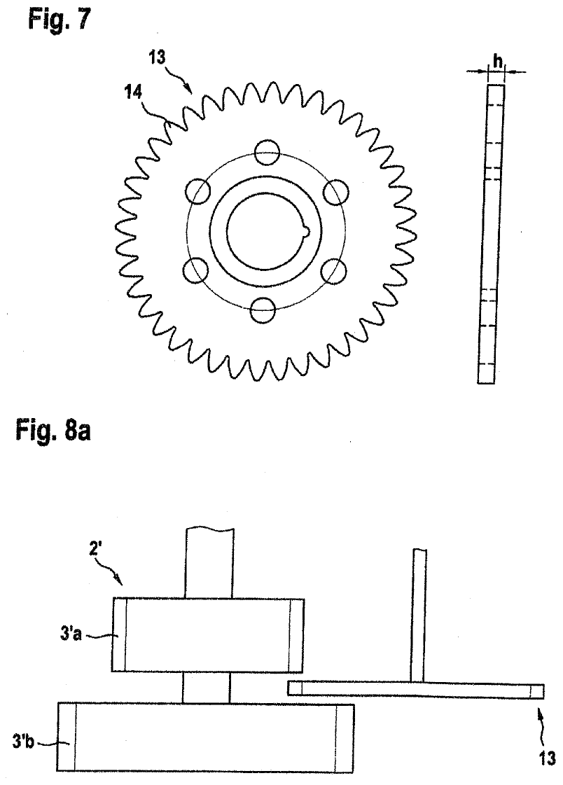

FIG. 7 shows a representation of a comparatively thin tool tooth arrangement,

FIGS. 8a, b show schematic representations of the machining of hard-to-reach tooth edges,

FIG. 9 schematically shows a chamfering unit, and

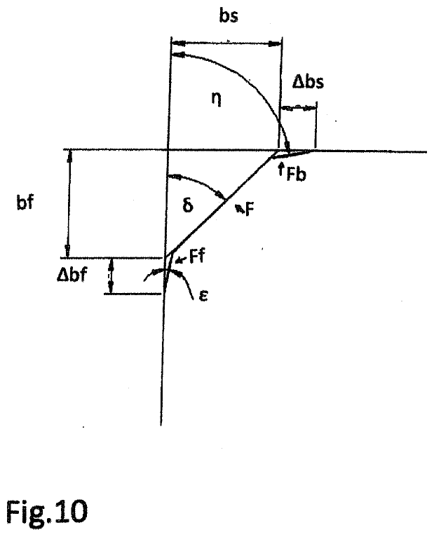

FIG. 10 describes a modification function.

FIG. 1 is a perspectival view of a workpiece 2 having an already manufactured internal tooth arrangement 3. In this embodiment, the internal tooth arrangement 3 is straight-toothed, but it is also possible to machine helical tooth arrangements, as well as external tooth arrangements.

The machining operation shown in FIG. 1 takes place on the lower end face 2b of the workpiece 2; in this exemplary embodiment, the tooth edges of the substantially involute teeth 4 of the internal tooth arrangement 3 are to be provided with a chamfer on the end edge 2b. It goes without saying that a further chamfering process can then also be carried out on the other end face 2a. However, the method is also suitable for rollable, non-involute workpiece tooth arrangements.

Machining is carried out with a tool tooth arrangement 13. For this purpose, a disc-shaped tool 10 is provided in this exemplary embodiment, which is externally toothed with the tool tooth arrangement 13. In this exemplary embodiment, the tool tooth arrangement 13 is the counter-tooth arrangement of the internal tooth arrangement 3. This means that, when the workpiece 2 and the tool 10 mesh with each other in synchronous rolling coupling, the teeth 14 of the tool tooth arrangement 13 immerse into the tooth gaps formed between the teeth 4 of the internal tooth arrangement 3 and roll off on the workpiece tooth flanks. The envelope of the rolling positions of the tool teeth 14 reflects the substantially involute profile on the tooth flank of the workpiece tooth 4. If, as in preferred method embodiments, machining is carried out using the single-flank process, the tooth thicknesses of the tool teeth 14 can also be designed to be thinner than is required for a contacting, two-flank rolling engagement. As can also be seen from FIG. 1, no axis intersection angle is provided between the rotational axes C of the workpiece tooth arrangement 3 and B of the tool tooth arrangement 13; the rotational axes B and C run in parallel. The further axes X, Y, and Z, which are shown as a coordinate system in FIG. 1, can be realized partially or entirely as linear machine axes of a machine tool (not depicted), such as Z (feed, parallel to C), X radial axis (center distance direction), Y tangential direction.

The relative position between the tool tooth arrangement 13 and the workpiece tooth arrangement 3 shown in FIG. 1 is substantially the situation at the start of machining. Before the start of machining, the edges 6 set between the end face 2b of the workpiece 2 and the adjacent tooth flanks of the teeth 4 are still sharp-edged, for example, in a shape similar to that resulting from a previous method for producing the internal tooth arrangement 3, for example, by gear skiving, gear hobbing or gear shaping, or other shaping methods, wherein primary burrs formed during the machining to produce tooth arrangements have possibly already been removed.

The objective of the tooth edge machining of this exemplary embodiment and numerous preferred method embodiments is the formation of a chamfer 8 at the location of the former tooth edge 6, as is shown, for example, in the illustration of FIG. 2. For the purpose of an enlarged illustration, FIG. 2 shows only the region of a tooth gap 5 near the base and the region of a tool tooth 14 near the tip.

A preferred example for producing the chamfer 8 will now be described with reference to FIG. 3a. An axial relative movement moves the workpiece tooth arrangement 13 by Δz above the height level of the lower end face 2b of the workpiece tooth arrangement 3, as seen axially. In addition, the envelope of the tool tooth rolling positions is shifted by an amount in the tangential direction Y that corresponds to a chamfer width w, which in this embodiment, for example, is 0.3 mm, due to an additional rotation ΔC of the workpiece relative to the phase position of the synchronized rolling coupling, for example. As a result, a sharp edge 19, which is provided between the end face 12 of the tool 10 and the machining surface 18 formed by the tooth flank surface of the tool tooth arrangement 13 on the tool 10, cuts off material on the end face 2b of the workpiece 2 while executing the rolling movement of the rolling engagement. In this case, the cutting movement is substantially in the plane orthogonal to the rotational axis C. It ends at a distance from the former tooth edge 6 in the size of the chamfer width w. By repeating this process with the tool 10 immersed axially deeper, but with a reduced shift by ΔY, the next step only reaches to w−ΔY during the next rotation, and so on, as can be seen in FIG. 3a. This thus results in a removal in slices of different cutting depths in the tangential direction and thus also of different extensions in the flank normal direction. At the end of the axial movement when the axial penetration depth is reached at the level of the desired chamfer depth d, the shift is again at zero, and, in this exemplary embodiment of a realization of the transverse movement via an additional rotation ΔC, the phase position of the synchronous rolling coupling is reached again.

If the shifting movement were to be effected only via linear machine axes, the phase position of the synchronous rolling coupling would be maintained during machining, and the effect of the removal in slices is achieved by a corresponding shift of the envelope via machine axis settings—for example, via the tangential axis Y. An action or interaction of the radial axis X is also conceivable. Moreover, combinations made up of axis movements X, Y; X, ΔC; Y, ΔC; X, Y, ΔC can be used. An involvement of the radial axis is preferred if a base chamfer is also to be created, as shown in FIG. 2.

Preferably, and as in this example, the axial movement will take place by way of a continuous feed movement with an adjustable feed rate per workpiece rotation. In the exemplary embodiment shown, for example, a workpiece speed of 1,000 rpm and a feed rate per workpiece rotation of 0.02 mm is set. For producing the chamfer shown in FIG. 3 with, for example, a chamfer width of approximately 0.3 mm and a chamfer depth d of also approximately 0.3 mm corresponding to a chamfer angle of approximately 45°, 15 workpiece rotations are carried out (for the sake of simplicity, FIG. 3 and the enlarged cutout in FIG. 3a show only a smaller number of stages of the removal in steps and in slices).

For smoothing the surface of the chamfer 8, the edge 19 of the tool tooth arrangement 13 is in this exemplary embodiment once again guided along the chamfer 8. For this purpose, the movement direction is reversed in the axial direction, and the relationship between the shifting of the envelope and the current axial immersion depth is maintained, but preferably a phase shift by a is provided preferably in the range [90°-270° ]. It would also be possible to work with a lower feed rate during the emerging movement than during the immersion movement. A momentary situation of this smoothing retreating movement is shown in FIG. 4.

FIG. 5 shows again how the envelope 28 is offset from the individual rolling positions 29i in relation to its zero position, which corresponds to the profile of the workpiece tooth flank, due to the shifting movement.

FIGS. 6a and 6b once again show shifting movements, as well as the single-flank method selected in preferred method embodiments (right and left flank are not chamfered simultaneously, but one after the other, but in this example with the same tool).

FIG. 7 is a plan view and a side view of a chamfering tool. From the latter, it can be seen that the disk thickness h of the tool tooth arrangement in this exemplary embodiment is only 3 mm. The chamfering wheel shown in FIG. 7 has 40 teeth with a module of 2 and an engagement angle of 20°. It goes without saying that the tooth arrangement data, such as the number of teeth or the disk thickness, can also assume other values.

Due to the tooth arrangement axis of the tool tooth arrangement being aligned parallel to the tooth arrangement axis of the workpiece tooth arrangement, chamfering wheels with a comparatively thin design are also well suited for machining hard-to-reach tooth edges, such as in the situation schematically shown in FIG. 8a, in which a workpiece 2′ has two different external tooth arrangements 3′, and the lower end face of the upper tooth arrangement 3′a is only at a small axial distance from the upper end face of the lower tooth arrangement 3′b. In FIG. 8b, the tool is in the form of a tandem tool that carries two tool tooth arrangements. The one tool tooth arrangement 13′a is used for chamfering the workpiece tooth arrangement 3′a, and the second tool tooth arrangement 13′b is used for chamfering the other workpiece tooth arrangement 3′b.

It can also be seen from FIGS. 8a, b that the presented method can also be used to chamfer external tooth arrangements similar to the chamfered internal tooth arrangement 3 described with reference to FIG. 1.

It is also understood that, even though FIG. 1 shows the chamfering method for a straight tooth arrangement, the method can be used to chamfer helical tooth arrangements as well. In this case, the tool tooth arrangement could be designed to match the rolling engagement with parallel axes as helical tooth arrangements to match the helix angle of the workpiece tooth arrangement. Alternatively, narrow, and in particular conical, but still straight-toothed tool tooth arrangements can be taken into consideration.

A chamfering unit 100 shown in FIG. 9 is capable of positioning the tool rotational axis B using three linear axes X, Y, Z, realized via corresponding carriage arrangements 110, 130, 120, relative to the workpiece rotational axis C (C parallel to B). The axis movements X, Y, Z, B, C are NC-controlled via controller 99. For an alternative, simpler design, the carriage 130 could also be omitted.

The chamfering unit 100 schematically shown in FIG. 9 could be integrated into a gear-cutting machine whose tool-side main spindle carries a tool that produces the workpiece tooth arrangement, such as a skiving wheel, a hob, or a gear-shaping wheel. Then the chamfering could still be carried out in the same workpiece clamping process as the main machining, or also at another location, transported by an appropriate automation, such as a ring loader, gripper, or a double spindle arrangement, from the location of the main machining to the location of the chamfering. Likewise, the chamfering unit can be designed as an independent chamfering machine, and the workpieces can be received by a workpiece automation, also from several gear-cutting machines, which deliver the tooth arrangements already produced for supplementary tooth machining.

In particular, if the main machining and the supplementary machining are not carried out in the same clamping process of the workpiece, it is provided that the (chamfering) machining unit also have means for centering, such as non-contact centering sensors, in order to determine the in-phase relative rotational position for the synchronous rolling coupling.

A modification function is now explained with reference to FIG. 10. A target geometry of a chamfer F defined by a chamfer angle δ of, in this case and not limited to, 45°, and a chamfer width bs is shown for a straight tooth arrangement. However, by means of the modification function already explained above, the machine axle control is not based upon these basic chamfer data, but data of a virtual chamfer corresponding to the representation in FIG. 10 with additional bevel regions Fs at the end face with angles rn of, here by way of example, approximately 80° and Ff at the tooth flank of, here also by way of example, 10°. The positioning of the bevels is such that the virtual chamfer width bs+Δbs greatly exceeds the target chamfer width (only for representational purposes), as shown; the actually widening set may be only a few %. The same applies to the alternatively and/or additionally modified transition to the flank with a modified extension bf+Δbf relative to bf. Since more material is removed instead of the machine axis being controlled for the target geometry, even in the event of material shifts due to compressive forces during the machining, material warps appearing with respect to the virtual geometry do not become material warps with respect to the target geometry.

Moreover, the invention is not limited to the embodiments shown in the previous examples. Rather, the individual features of the above description and the following claims may be essential, individually and in combination, for implementing the invention in its different embodiments.

1. Method for machining a tooth edge, formed between a tooth flank and an end face (2b) of a workpiece tooth arrangement (3), by means of a tool tooth arrangement (13), in which method the tooth arrangements (3, 13) rotate about their respective tooth arrangement rotational axes (C, B) in mutual rolling coupling,
characterized in that
the two tooth arrangement rotational axes (C, B) are substantially parallel to each other, and the machining is carried out over a plurality of workpiece rotations, wherein a first relative movement (Z), parallel to the workpiece rotational axis, between the workpiece tooth arrangement (3) and the tool tooth arrangement (13) is carried out, and the position of the envelope (28) of the tool tooth rolling positions (29i) is shifted relative to the engagement position of said envelope with the tooth flank of the workpiece tooth arrangement in the plane (X-Y) orthogonal to the workpiece rotational axis (C), transversely to the profile of the workpiece tooth arrangement, by means of a second relative movement (V), which is varied according to the movement state of the first relative movement.

2. Method according to claim 1 for machining a tooth flank region of a workpiece tooth arrangement (3) formed between a tooth flank and an end face (2b) of a workpiece tooth arrangement (3) by means of a tool tooth arrangement (13), in which method the tooth arrangements (3, 13) rotate in rolling coupling about their respective tooth arrangement axes (C, B), and in which the machining on the tooth flank region creates a new tooth arrangement surface, in which the machining is carried out over a plurality of workpiece rotations, wherein a first relative movement (Z) with a directional component parallel to the workpiece rotational axis is carried out between the workpiece tooth arrangement (3) and the tool tooth arrangement (13), and the position of the envelope (28) of the tool tooth rolling positions (29i) is shifted relative to the engagement position of said envelope with the tooth flank of the workpiece tooth arrangement as seen in projection onto the plane (X-Y) orthogonal to the workpiece rotational axis (C), transversely to the profile of the workpiece tooth arrangement, by means of a second relative movement (V), which in particular is varied according to the movement state of the first relative movement, and as a result, material is removed along a cutting surface during one pass of a respective workpiece rotation, wherein the shape of the new tooth arrangement surface is composed of the end regions of the cutting surfaces of the plurality of workpiece rotations.

3. Method according to claim 1, in which a transverse movement (Q) of the workpiece tooth arrangement and/or tool tooth arrangement running transversely to the center distance axis of the rotational axes contributes to the second relative movement.

4. Method according to claim 3, in which the transverse movement (Q) comprises an additional rotation (ΔC) of the workpiece tooth arrangement.

5. Method according to claim 3 in which the transverse movement comprises a movement of a linear machine axis (Y) whose directional component orthogonal to the workpiece rotational axis and orthogonal to the center distance axis (X) predominates over the respective directional component along these axes.

6. Method according to claim 1 in which the tooth edge in the tooth base of the workpiece tooth arrangement is also machined.

7. Method according to claim 1 in which a radial movement (ΔX) of the workpiece and/or the tool tooth arrangement running in the direction of the center distance axis of the rotational axes contributes to the second relative movement.

8. Method according to claim 6 in which the shape of a chamfer (8) in the tooth base is effected by adjusting the radial movement according to the movement state of the first relative movement, and the shape of the material removal at the tooth edge in the tooth flank region is determined by adjusting the transverse movement according to the movement state of the first relative movement and the movement state of the radial movement.

9. Method according to claim 4 in which the profile of the material removal in the tooth height direction is determined by superimposing the transverse movement contributions from the additional rotation (ΔC) and the linear machine axis movement (ΔX, ΔY).

10. Method according to claim 1 with a further machining pass with otherwise identical or phase-shifted coupling of the first and second relative movement, but with movement control carried out with the reverse movement direction of the first relative movement.

11. Method according to claim 1 in which the rotational speed at the tooth tip of the workpiece is at least 10 m/min.

12. Method according to claim 1 in which a chamfer (8) is produced on the tooth edge during machining.

13. Method according to claim 1 in which the profile of the tool tooth arrangement is substantially that of the counter-tooth arrangement of the workpiece tooth arrangement with respect to the rolling coupling.

14. Method according to claim 1 which is carried out using the single-flank method, wherein the other tooth flank(s) is/are machined following the machining of one tooth flank on one of the respective tooth gap(s) of the workpiece.

15. Method according to claim 13, in which the machining of the other tooth flank(s) is carried out with the same tool and/or in the same clamping process as the one tooth flank.

16. Method according to claim 1 in which the tooth thickness of the tool tooth arrangement is reduced when compared to the tooth thickness required for the rolling coupling for two-flank machining.

17. Method according to claim 1 in which the dimension (h) of the tool tooth arrangement along the tool rotational axis is less than 1.5 cm.

18. Method according to claim 1 for machining a tooth flank region of a workpiece tooth arrangement (3) formed between a tooth flank and an end face (2b) of a workpiece tooth arrangement (3) using a machining tool (13), in which a new tooth arrangement surface in the form of a chamfer is formed by the machining at the tooth flank region, with a modification function in which modified machine axis controls are associated with a virtual geometry for the new tooth arrangement surface, and the virtual geometry in a first transition region from a central region to the end face (2b) and/or in a second transition region from the central region to the tooth flank deviate from a target geometry on the workpiece in a manner that removes more material, wherein the processing is based upon the modified machine axis controls after selection of the modification function or automatically in order to counteract any formation of material warps on the processed tooth flank region caused by compressive forces between the machining tool and the workpiece tooth arrangement.

19. Chamfering tool (10) for machining a tooth edge formed between a tooth flank and the end face of a workpiece tooth arrangement, with machining carried out substantially with tooth arrangement rotational axes parallel to each other in mutual rolling coupling and in the form of a tool tooth arrangement with machining surfaces formed by the tooth flanks of the tool tooth arrangement the method of claim 1.

20. Control program having control instructions, which, when executed on a gear-cutting machine, controls the machine for carrying out a method according to claim 1.

21. Gear-cutting machine (100) having at least one workpiece spindle for rotatingly driving a workpiece tooth arrangement about its workpiece rotational axis (C), and at least one tool spindle for rotatingly driving a tool tooth arrangement about its rotational axis (C), at least one first machine axis (Z) which allows for a first relative movement, parallel to the workpiece rotational axis, between the workpiece tooth arrangement and tool tooth arrangement, characterized by a control device (99) having control instructions for carrying out a method according to claim 1.
